(19) United States
(12) Patent Application Publication
(10) Pub. No.: US 2011/0113333 A1
(43) Pub. Date: May 12, 2011

(54) CREATION AND DELIVERY OF RINGTONES OVER A COMMUNICATIONS NETWORK

(76) Inventors: John Lee, Golden Beach, FL (US); Louis Siu, Brooklyn, NY (US)

(21) Appl. No.: 12/617,432

(22) Filed: Nov. 12, 2009

(51) Int. Cl. H04W 4/12; H04M 1/663; G06F 3/01

(52) U.S. Cl. 715/716; 455/412.2; 455/466

(57) ABSTRACT

A method on a server for providing a ringtone based on a video can be provided. The method can include providing a graphical user interface to a user over a communications network and receiving, via the graphical user interface, identifying information for a video file on a third party server. The method can further include sending to the third party server a request for the video file, wherein the request is based on the identifying information and receiving the video file from the third party server. The method can further include streaming the video file to the user via the graphical user interface and receiving, via the graphical user interface, segment data identifying a segment of the video file. The method can further include generating a ringtone from the video file based on the segment data and transmitting the ringtone to the user.

### BACKGROUND OF THE INVENTION

1. Field of the Invention

The present invention relates to the field of ringtones and more particularly to software that facilitates the creation and delivery of custom ringtones over a communications network.

2. Description of the Related Art

A ringtone is the sound made by a telephone to indicate an incoming call or text message. The term is most often used today to refer to customizable sounds used on mobile phones. Consumers utilize different ringtones for a variety of reasons. One popular reason is recreation. Consumers enjoy hearing ringtones by their favorite artists, their favorite band or from their favorite movie. Another reason consumers use different ringtones is to identify a caller. Mobile phones today allow a user to assign a ringtone to a particular incoming number such that the user can identify a caller by the sound of the ringtone. Even more reasons consumers use different ringtones are to accommodate a particular time of year (i.e., Christmas songs during the holidays) or simply personal preferences of the consumer (i.e., a baseball-related song for a baseball enthusiast).

As a result of the need for different ringtones by consumers, a sizable ringtone industry has emerged. Today, consumers have multiple options available to them for obtaining ringtones for their mobile phones. Ringtones can be downloaded by consumers via their mobile phones, their home personal computers or via kiosks. Because ringtones are often based on popular songs, the ringtone industry is a particularly profitable part of the music industry. Estimates put the ringtone industry at $2 billion in worldwide sales in 2005 while sales of ringtones in the United States are estimated at $714 million for 2007. Further, whereas ringtones originally only featured popular music, today ringtones can include excerpts from movies/television, popular sound effects, sounds of nature, etc.

Consumers' demand for ringtones has further spawned a ring tone maker industry that allows consumers to create their own custom ringtones. A ringtone maker allows a consumer to use a song from his personal music collection and create a custom ringtone for his mobile phone. One of the problems with such ringtone makers is that the consumer is limited to his personal music collection. Even if the consumer is allowed access to an online music collection, the consumer's selection is still limited to that collection. Another problem with such ringtone makers is that the consumer is not given the option to create a ringtone using other types of files. The above limitations restrict the options available to consumers desiring to create their own custom ringtones.

Another problem with currently available ringtone makers is the lack of information about other ringtones made by other consumers. When visiting a ringtone maker web site, there is little, if any, information provided about how other consumers created custom ringtones. This information could be helpful since it is often the case that consumers share similar proclivities in their selection of ringtones. There does not exist, however, an interface that allows consumers to browse or view the selections of other users that created their own custom ringtones.

Therefore, there is a need to overcome the deficiencies with the prior art and more particularly for a more efficient way to facilitate the creation of custom ringtones by consumers over a communications network.

### BRIEF SUMMARY OF THE INVENTION

Embodiments of the present invention address deficiencies of the art in respect to creation of custom ringtones and provide a novel and non-obvious method for creating custom ringtones from video. In an embodiment of the invention, a method on a server for providing a ringtone based on a video can be provided. The method can include providing a graphical user interface to a user over a communications network and receiving, via the graphical user interface, identifying information for a video file on a third party server. The method can further include sending to the third party server a request for the video file, wherein the request is based on the identifying information and receiving the video file from the third party server. The method can further include streaming the video file to the user via the graphical user interface and receiving, via the graphical user interface, segment data identifying a segment of the video file. The method can further include generating a ringtone from the video file based on the segment data and transmitting the ringtone to the user.

In another embodiment of the invention, an alternative method on a server for providing a ringtone based on a video can be provided. The alternative method can include providing a graphical user interface to a user over a communications network and receiving, via the graphical user interface, identifying information for a video file on a third party server. The method can further include accessing the video file based on the identifying information, streaming the video file to the user via the graphical user interface and receiving, via the graphical user interface, segment data identifying a segment of the video file. The method can further include generating a ringtone from the video file based on the segment data and transmitting the ringtone to the user.

In another embodiment of the invention, a computer program product comprising computer instructions for generating a ringtone based on a video can be provided. The computer program product can include computer instructions for displaying a graphical user interface for a user, receiving, via the graphical user interface, identifying information for a video file on a third party server, sending to the third party server a request over a communications network for the video file, wherein the request is based on the identifying information, receiving the video file from the third party server over the communications network, playing the video file for the user via the graphical user interface, receiving, via the graphical user interface, segment data identifying a segment of the video file, generating a ringtone from the video file based on the segment data and transmitting the ringtone to a mobile phone of the user.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory, only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for providing custom ringtone creation over a communications network, in accordance with one embodiment of the present invention;

FIG. 2 is a flow chart describing the control flow of the process for custom ringtone creation based on a video over a communications network, in accordance with one embodiment of the present invention;

FIG. 3 is an illustration of a web browser providing a system for custom ringtone creation based on a video over a communications network, in accordance with one embodiment of the present invention;

FIG. 4 is another illustration of a web browser providing a system for custom ringtone creation based on a video over a communications network, in accordance with one embodiment of the present invention.

### DETAILED DESCRIPTION OF THE INVENTION

Embodiments of the present invention address deficiencies of the art in respect to ringtones and provide a novel and non-obvious method, system and computer program product for allowing a user to create custom ringtones over a communications network. The present invention overcomes the problems with the prior art by providing a fast and user-friendly interface that allows a user to create custom ringtones from videos. This is advantageous over the prior art as it broadens the types of files from which ringtones can be created, thereby creating more options for custom ringtone consumers. Moreover, the present invention allows a user to create ringtones from videos available on a server over a communications network, such as videos on a video sharing web site. Again, this is advantageous as it increases the pool of content from which ringtones can be created. More specifically, the present invention opens up the content on any online video site as potential content from which ringtones can be created.

The present invention allows a user to access the videos available on a server over a communications network and utilize a graphical user interface to indicate a segment of the video file from which to create a custom ringtone. The identified ringtone is then created and transferred to the user via email, download or MMS message. In another embodiment, for any video selected, the user may view the segments that were identified by other users for custom ringtone creation. The user may also view, for any video selected, the number of users that selected each segment for custom ringtone creation. These features are advantageous as they allow users to save the time and effort of identifying segments of a video for custom ringtone creation, by simply selecting the segments identified by others. These features are further advantageous as they allow users to identify the popularity or recognition of videos, songs or sounds, as well as the popularity of certain segments of those videos, songs or sounds.

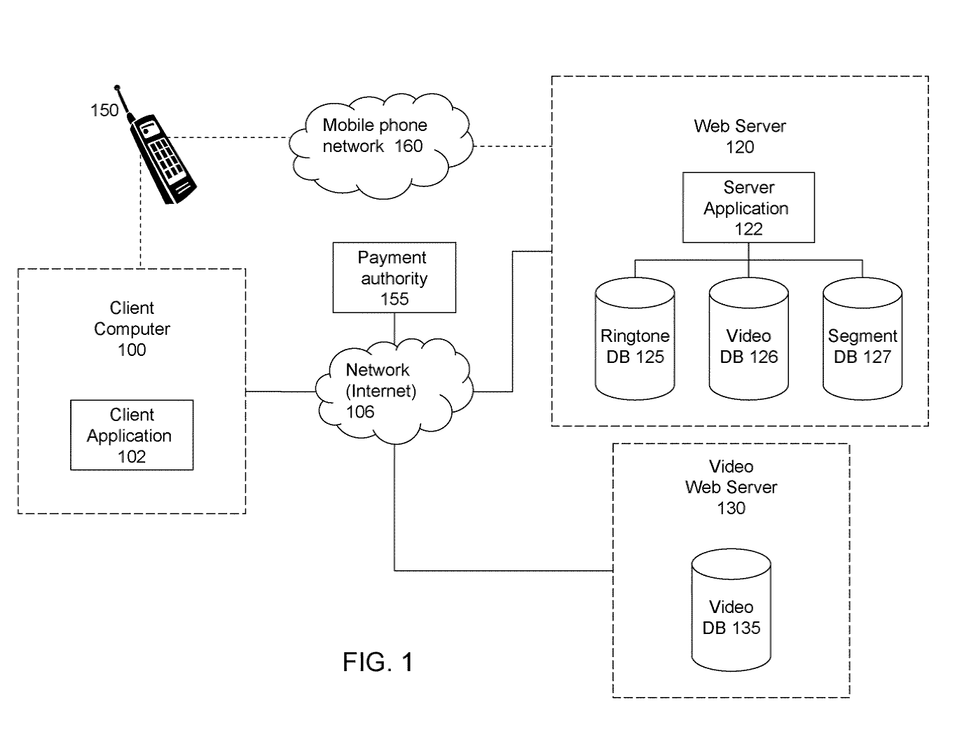

Referring now to the drawing figures in which like reference designators refer to like elements, there is shown in FIG. 1 an illustration of a block diagram showing the network architecture of a software application in accordance with the principles of the present invention. FIG. 1 shows an embodiment of the present invention wherein client computer 100 interacts with web server 120 and video web server 130 over a network 106, which can be a circuit switched network, such as the Public Service Telephone Network or a packet switched network such as the Internet or the World Wide Web.

Web server 120 includes a software engine that delivers applications, videos and other data to client computer 100. Web server 130 includes a software engine that delivers videos to server 120 and/or client computer 120 based on search parameters or identifying information selected by the client. The software engines of servers 120, 130 may perform other video delivering processes such as video streaming or any other standard for transferring multimedia data in a stream of packets that are interpreted and rendered, in real time, by a software application as the packets arrive. It should be noted that although FIG. 1 shows only one client computer 100 and web server 130, the system of the present invention supports any number of client users and web servers connected via network 106.

In one embodiment of the present invention, the network application provided by the web server 120 of FIG. 1 is a client-server application having a client portion 102 that resides on client computer 100 and a server application 122 that resides on web server 120. For example, the network application can be a web interface that is accessed by client computer 100 via network 106. In another embodiment of the present invention, the web server 120 delivers to client 100 an application having only a client portion 102 that resides on client computer 100. For example, the application 102 can be a web browser extension or web browser add-on, which is an installable enhancement to a web browser. The web browser extension or web browser add-on may be written using any of the following technologies: CSS (Cascading Style Sheets), DOM (Document Object Model), JavaScript, XPCOM (Cross-Platform Component Object Model), XPConnect, XPI (Cross-Platform Installer), XUL (XML User Interface Language).

Server application 122 and client application 102 include program logic comprising computer source code, scripting language code or interpreted language code that is compiled to produce computer instructions that perform various functions of the present invention. In one embodiment of the present invention, the program logic is a scripting language such as ECMAScript, CSS, XML (Extensible Markup Language), XSLT (Extensible Style-sheet Language Transformations), Javascript, AJAX (Asynchronous JavaScript and XML), XUL, JSP, PHP, and ASP (Active Server Pages).

FIG. 1 further shows that web server 120 includes a ringtone database 125, a video database 126 and a segment database 127. Client computer 100 may also include its own database. Database 125 is used to store ringtones that have been created at the instruction of users, while video database 126 stores videos that have either been uploaded by users, obtained by server 120 or downloaded by server 120 from video server 130. Database 127 stores segment data created by users of server 120. Segment data is defined as a start time and an end time for a particular video file. Thus, segment data includes at least the following data: a start time indicator (i.e., a numerical value), an end time indicator and a unique video identifier (i.e., a text string or a numerical value). Segment data may also include a number indicating how many users have previously chosen or identified a particular segment when creating a custom ringtone using the present invention.

Video server 130 is a web server that stores videos and delivers them to clients, such as client 100 or server 120, over a communications network such as network 106. Server 130 may be a popular video sharing site available over the Internet, such as the world famous youtube.com web site. Note that although video server 133 is shown as a separate entity, in one embodiment of the present invention, the functions of video server 130 may be integrated with another entity, such as web server 120.

FIG. 1 also shows a payment authority 155 to effectuate payments by users for ringtones. In one embodiment of the present invention, the payment authority 155 is a payment gateway, which is an e-commerce Application Service Provider (ASP) service that authorizes payments for e-businesses, online retailers, or traditional brick and mortar businesses. A payment gateway is the equivalent of a physical point-of-sale terminal located in most retail outlets. Payment gateways encrypt sensitive information, such as credit card numbers, to ensure that information passes securely between the customer and the merchant. A payment gateway facilitates the transfer of information between a payment portal (such as a website) and the acquiring bank, quickly and securely. When a customer orders a product or service from a payment gateway enabled merchant, the payment gateway performs a variety of tasks to process the transaction. Payment gateways accept payment via the use of credit cards, charge cards, bank cards, gift cards, account cards, etc.

FIG. 1 further shows a mobile phone, 150, which may be connected to the client computer 100 via a wired connection, such as a wired USB connection, or a wireless connection, such as using the Bluetooth wireless standard. Also, mobile phone 150 may be connected to the mobile phone network 160 via a wireless connection. The web server 120 may also be connected to the mobile phone network 160.

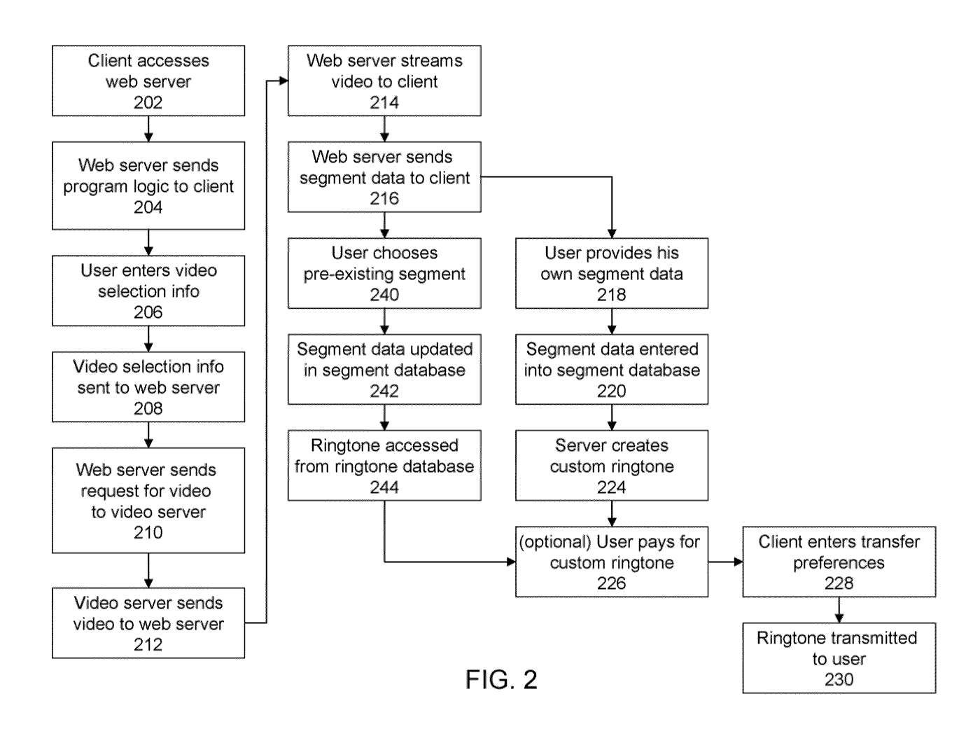

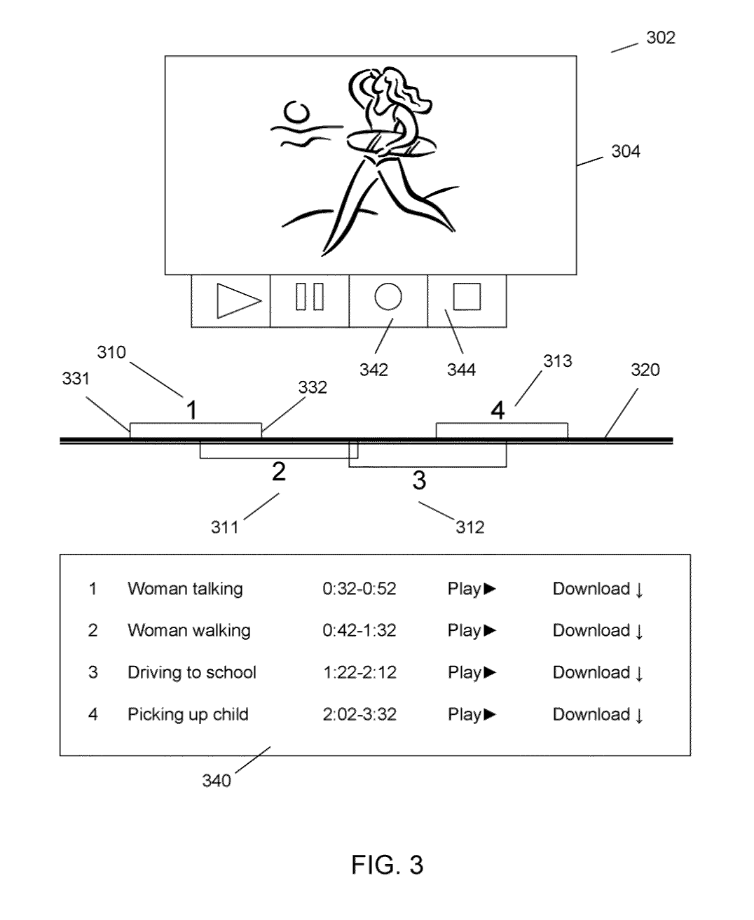

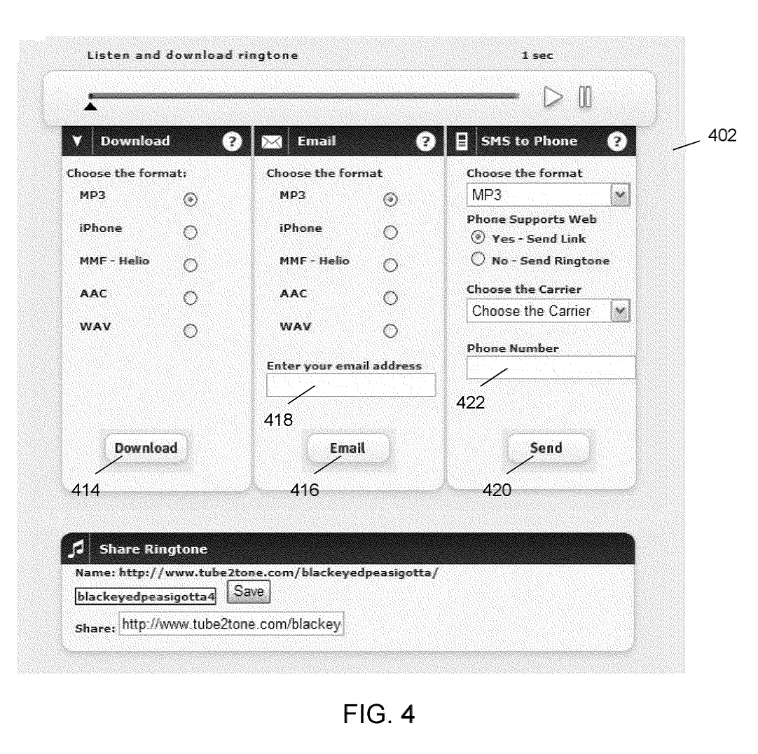

FIG. 2 is a flow chart describing the control flow of the process for custom ringtone creation based on a video over a communications network, in accordance with one embodiment of the present invention. The flow chart of FIG. 2 is described in association with FIG. 3 and FIG. 4, which show illustrations of a web browser providing a system for custom ringtone creation based on a video over a communications network, in accordance with one embodiment of the present invention.

In a first step 202, a client application 102, such as a web browser, executing on client computer 100 accesses web server 120 over network 106. Client application 102, may, for example, access the web site operated by web server 120 by sending an HTTP request to web server 120. In step 204, the server application 122 of web server 120 transmits program logic to client 100. The program logic displays a graphical user interface, such as interface 302 (see FIG. 3), on client 100. In step 206, the user of computer 100 enters identifying information for a video into the graphical user interface, wherein the identifying information can be a text string of key words, a URL or a click on an icon representing a video. In step 206, the user of computer 100 may also browse or search videos using various well known methods of searching for information via a graphical user interface.

In step 208, the identifying information entered by the user is transmitted to server 120, such as in an HTTP request. In step 210, the server application 122 of server 120 sends a request over network 106 to video web server 130 for the video identified by the user, wherein the request includes identifying information for the desired video. In step 212, the video web server 130 transmits the video file of the desired video to server 120 over network 106. The server 120 may store the received video in video database 126. In one alternative to steps 210-212, the desired video resides in video database 126 of server 120 and therefore the server application 122 simply searches for and accesses the desired video in database 125.

In one embodiment of the invention, wherein the program logic of applications 102 and 122 are embodied in the program logic of a web browser extension residing solely in client application 102, an alternative to steps 208-212 exists. In this alternative, the client application 102 of client 100 sends a request over network 106 to video web server 130 for the video identified by the user, wherein the request includes identifying information for the desired video. Subsequently, the video web server 130 transmits the video file of the desired video to client 100 over network 106. In another alternative to steps 210-212, the desired video resides in video database 126 of server 120 and therefore the server application 122 simply searches for and accesses the desired video in database 125.

The video file transferred from server 130 to server 120 and/or from server 120 to client 100 may exist in any of a variety of formats, such as AVI, FLV, MOV, MPEG, XVID, SWF, MPEG4, WMV. RM and DIVX. Further, the transfer of the video file may be streamed, wherein video data is transferred in a stream of packets that are interpreted and rendered, in real time, by a software application as the packets arrive. Additionally, the transfer of the video file may include compression and/or encryption upon transmission and decompression and/or decryption upon reception.

Next, in step 214, the server application 122 of server 120 streams the video to the graphical user interface 302, as seen in video display 304. In the web browser extension alternative, the video is accessed by client application 102 and played in video display 304 of interface 302.

In step 216, server application 122 accesses various segment data 310, 311, 312, 313 for the selected video from segment database 127 and transmits the data to client application 102 for display in interface 302. Note that FIG. 3 shows a timeline 320 for the selected video. Each segment data shows a start time and an end time within the timeline 320 such that each segment data visually indicates the location of a start time and an end time for each segment in the timeline 320. Segment data 310, for example, shows a line icon 331 indicating a start time within the timeline 320 and a line icon 332 indicating an end time within the timeline 320. Segment data 310 may also be shown as a bracket visually indicating the location of the start time and end time for the segment in the timeline 320. In one embodiment, segment data 310, 311, 312, 313, as displayed in interface 302, may also include a number indicating how many users have previously chosen a particular segment when creating a custom ringtone using the present invention.

Note that FIG. 3 also shows an information list 340 including a list of segments 310, 311, 312, 313. For each segment, the list shows a text description of the segment, a numerical start time and end time of the segment in the video, a play button that plays the segment in the video display 304 when pressed and a download button that transfers to the user a custom ringtone created from the segment when pressed.

Next, the user decides whether to use a preexisting segment (such as segments 310-313, as shown in FIG. 3) in step 240, or to create his own custom ringtone by creating his own segment in step 218. In step 218, the user enters his segment data into interface 302. In one embodiment, the video in display 304 commences playing and the user presses the record button 342 when he desires his segment to begin and presses the stop button 344 when he desires his segment to end. In another embodiment, the user simply clicks on two locations in the timeline 320 to indicate a start time within the timeline 320 and an end time within the timeline 320.

In step 220, the segment data entered by the user is transmitted to the server 120 and server application 122 stores the segment data in segment database 127. In the web browser extension alternative, the segment data entered by the user is not transmitted to the server 120.

In step 224, the server application 122 creates a ringtone from the video based on the segment data entered by the user. The created ringtone may be stored in the ringtone database 125 for future use by later users. In the web browser extension alternative, the client application 102 creates a ringtone from the video based on the segment data entered by the user.

In optional step 226, the user may input electronic payment information (such as name, address, credit card information) into interface 402 for payment for the ringtone. In optional step 226, the payment authority 155 receives the electronic payment information and clears the user to receive the identified ringtone.

In step 228, the user is presented with and interacts with an interface 402 for entering the desired method for receiving the custom ringtone defined by the user. Interface 402 shows that the user may define an audio file format for the ringtone, such as MP3, iPhone, MMF/Helio, AAC and WAV. By pressing button 414, the user expresses a desire to download the ringtone to his mobile phone 150 via a connection to the computer 100. By pressing button 416, the user expresses a desire to receive the ringtone to his mobile phone 150 via an email sent to the mobile phone 150 at the email address specified by the user in text field 418. By pressing button 420, the user expresses a desire to receive the ringtone to his mobile phone 150 via an MMS (Multimedia Messaging Service) message sent to the mobile phone 150 at the mobile phone number specified by the user in text field 422. In step 228, the transfer preferences entered by the user in interface 402 are transmitted to the server 120. In the web browser extension alternative, the transfer preferences entered by the user in interface 402 are stored by the client application 102.

In step 230, the ringtone of the user is transmitted to the user via the preferred method. If so indicated by the user, server 120 may download the ringtone over network 106 to the computer 100, which, in turn, downloads the ringtone to the mobile phone 150 via a connection. If so indicated by the user, server 120 may transmit the ringtone to the mobile phone 150 via an email sent to the mobile phone 150 over network 160. If so indicated by the user, server 120 may transmit the ringtone to the mobile phone 150 via an MMS message sent to the mobile phone 150 over network 160. In the web browser extension alternative, the transferring entity is the client application 100, instead of the server 120.

In step 240, the user decides to choose a preexisting segment, i.e., a preexisting custom ringtone, already defined by a previous user. Note the preexisting segments 310-313 in FIG. 3. For example, the user may press one of the download buttons 353 corresponding to the desired pre-existing ringtone in interface 302. In step 242, the segment data corresponding to the desired pre-existing ringtone is updated in segment database 127. The updating may comprise simply the addition of one unit to the count of the number of users who have downloaded the corresponding ringtone, to account for the user performing step 240. In step 244, the ringtone corresponding to the segment data chosen by the user is accessed in ringtone database 125.

The present invention can be realized in hardware, software, or a combination of hardware and software in the system described in the figures above. A system according to a preferred embodiment of the present invention can be realized in a centralized fashion in one computer system or in a distributed fashion where different elements are spread across several interconnected computer systems. Any kind of computer system—or other apparatus adapted for carrying out the methods described herein—is suited. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allows a computer system to read such computer readable information.

In this document, the terms “computer program medium,” “computer usable medium,” and “computer readable medium” are used to generally refer to media such as main memory removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allows a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method on a server for providing a ringtone based on a video, comprising:
providing a graphical user interface to a user over a communications network;
receiving, via the graphical user interface, identifying information for a video file on a third party server;
sending to the third party server a request for the video file, wherein the request is based on the identifying information;
receiving the video file from the third party server;
streaming the video file to the user via the graphical user interface;
receiving, via the graphical user interface, segment data identifying a segment of the video file;
generating a ringtone from the video file based on the segment data; and
transmitting the ringtone to the user.

2. The method of claim 1, wherein the transmitting step comprises any one of:
uploading the ringtone to a computer of the user over the communications network;
transmitting an email including the ringtone to the user; and
transmitting an MMS message including the ringtone to a mobile phone of the user.

3. The method of claim 2, further comprising:
receiving, via the graphical user interface, a selection from the user indicating a preference to receive the ringtone at a computer of the user and uploading the ringtone to the computer of the user over the communications network.

4. The method of claim 2, further comprising:
receiving, via the graphical user interface, an email address for the user and transmitting an email including the ringtone to the user at the email address.

5. The method of claim 2, further comprising:
receiving, via the graphical user interface, a mobile phone number for the user and transmitting an MMS message including the ringtone to a mobile phone of the user.

6. The method of claim 2, further comprising:
displaying, via the graphical user interface, a plurality of segment data provided by other users, wherein each segment data corresponds to a pair of icons and wherein each pair of icons indicates a start and stop time for each segment data.

7. The method of claim 2, further comprising:
displaying, via the graphical user interface, an icon for each segment data, wherein each icon indicates how many other users selected corresponding segment data.

8. A method on a server for providing a ringtone based on a video, comprising:
providing a graphical user interface to a user over a communications network;
receiving, via the graphical user interface, identifying information for a video file;
accessing the video file based on the identifying information;
streaming the video file to the user via the graphical user interface;
receiving, via the graphical user interface, segment data identifying a segment of the video file;
generating a ringtone from the video file based on the segment data; and
transmitting the ringtone to the user.

9. The method of claim 8, wherein the transmitting step comprises any one of:
uploading the ringtone to a computer of the user over the communications network;
transmitting an email including the ringtone to the user; and
transmitting an MMS message including the ringtone to a mobile phone of the user.

10. The method of claim 9, further comprising:
receiving, via the graphical user interface, a selection from the user indicating a preference to receive the ringtone at a computer of the user and uploading the ringtone to the computer of the user over the communications network.

11. The method of claim 9, further comprising:
receiving, via the graphical user interface, an email address for the user and transmitting an email including the ringtone to the user at the email address.

12. The method of claim 9, further comprising:
receiving, via the graphical user interface, a mobile phone number for the user and transmitting an MMS message including the ringtone to a mobile phone of the user.

13. The method of claim 9, further comprising:
displaying, via the graphical user interface, a plurality of segment data provided by other users, wherein each segment data corresponds to a pair of icons and wherein each pair of icons indicates a start and stop time for each segment data.

14. The method of claim 9, further comprising:
displaying, via the graphical user interface, an icon for each segment data, wherein each icon indicates how many other users selected corresponding segment data.

15. A computer program product comprising computer instructions for generating a ringtone based on a video, the computer instructions comprising instructions for:
displaying a graphical user interface for a user;
receiving, via the graphical user interface, identifying information for a video file on a third party server;
sending to the third party server a request over a communications network for the video file, wherein the request is based on the identifying information;
receiving the video file from the third party server over the communications network;
playing the video file for the user via the graphical user interface;
receiving, via the graphical user interface, segment data identifying a segment of the video file;
generating a ringtone from the video file based on the segment data; and
transferring the ringtone to a mobile phone of the user.

16. The computer program product of claim 15, wherein the instructions for transferring comprise any one of:
instructions for uploading the ringtone to the mobile phone via a connection;
instructions for transmitting an email including the ringtone to the mobile phone; and
instructions for transmitting an MMS message including the ringtone to the mobile phone.

17. The computer program product of claim 16, further comprising instructions for:
receiving, via the graphical user interface, a selection from the user indicating a preference to receive the ringtone via the connection and uploading the ringtone to the mobile phone via the connection.

18. The computer program product of claim 16, further comprising instructions for:
receiving, via the graphical user interface, a mobile phone number for the mobile phone and transmitting an MMS message including the ringtone to the mobile phone.

19. The computer program product of claim 16, further comprising instructions for:
displaying, via the graphical user interface, a plurality of segment data provided by other users, wherein each segment data corresponds to a pair of icons and wherein each pair of icons indicates a start and stop time for each segment data.

20. The computer program product of claim 16, further comprising instructions for:
displaying, via the graphical user interface, an icon for each segment data, wherein each icon indicates how many other users selected corresponding segment data.
